(19) United States
(12) Patent Application Publication
(10) Pub. No.: US 2015/0365781 A1
(43) Pub. Date: Dec. 17, 2015

(54) SERVER SYSTEMS

(71) Applicants: INVENTEC (PUDONG) TECHNOLOGY CORPORATION, Shanghai (CN); INVENTEC CORPORATION, Taipei City (TW)

(72) Inventor: YING-XIAN HAN, Shanghai City (CN)

(21) Appl. No.: 14/469,220

(22) Filed: Aug. 26, 2014

(30) Foreign Application Priority Data
Jun. 17, 2014 (CN) 201410271137.0

(51) Int. Cl. H04W 4/00; G06F 9/44; G06F 9/445; H04L 29/08

(52) U.S. Cl. CPC H04W 4/008; H04L 67/1095; G06F 9/442; G06F 9/4416; G06F 8/65

(57) ABSTRACT

Disclosed herein are several server systems, each of which comprises a storage unit, a near field communication (NFC) module, and a central processing module. One embodiment further comprises a management module configured to manage the server system and to generate or modify a system datum. The storage unit stores the system datum. The NFC module, coupled with the storage unit, selectively accesses the system datum in the storage unit and transmits it by NFC. Another embodiment further comprises, in addition to the management module, a basic input/output system (BIOS) or a complex programmable logic device (CPLD), or replaces the management module with a baseboard management controller (BMC), the BIOS or the CPLD. In one embodiment, the NFC module comprises an NFC transceiver unit and an NFC control unit, the latter configured to access the system datum in the storage unit through or bypassing the BMC.

### CROSS-REFERENCE TO RELATED APPLICATIONS

This non-provisional application claims priority under 35 U.S.C. §119(a) on Patent Application No. 201410271137.0 filed in People's Republic of China on 6/17/2014, the entire contents of which are hereby incorporated by reference.

### TECHNICAL FIELD

The present invention relates to server technology, particularly to server systems incorporating near field communication.

### BACKGROUND

As widespread as various wireless communication means are, data exchange between a server and the outside world is still wired, as by hard disk or thumb drives. The associated inconvenience is exemplified by the fact that when the server implements the Intelligent Platform Management Interface (IPMI), the abundant and useful information generated by the IPMI must be transferred by wire to an external device before it can be read and analyzed indirectly by a management console. In addition, suppose that the said information is stored solely in the space belonging to the baseboard management controller (BMC) of the IPMI. The management console would not be able to retrieve that information and thereby diagnose and maintain the server if the BMC failed or was broken.

### SUMMARY

In light of the above, the present invention discloses several server systems, each of which comprises a near field communication (NFC) module.

One of the server systems disclosed comprises a central processing module, a management module, a storage unit, and an NFC module coupled with the storage unit. The management module is configured to manage the server system and to generate or modify a system datum. The storage unit is configured to store the system datum. The NFC module is configured to selectively access the system datum in the storage unit and to selectively transmit the system datum by NFC.

In one embodiment, the NFC module comprises an NFC transceiver unit and an NFC control unit. In one embodiment, the NFC control unit is coupled with the management module and configured to access the system datum in the storage unit via the management module. In another embodiment, the NFC control unit is coupled with the storage unit via a signal transmission path that bypasses the management module. The NFC control unit is then configured to access the system datum in the storage unit via the signal transmission path.

In one embodiment, the NFC module, by NFC, is further configured to read data stored in an external device or communicate with another NFC module of another server system. The NFC module may be detachably connected with a motherboard of the server system.

As enumerated below, the management module may be further incarnated as a baseboard management controller (BMC), a basic input/output system (BIOS), or a complex programmable logic device (CPLD).

Another disclosed server system comprises a central processing module, a BMC, a storage unit, and an NFC module coupled with the storage unit. The BMC is configured to monitor and manage the server system and to generate or modify a system datum relevant to the server system. The storage unit is configured to store the system datum. The NFC module is configured to selectively access the system datum in the storage unit and to selectively transmit the system datum by NFC.

In one embodiment, the NFC module comprises an NFC transceiver unit and an NFC control unit. In one embodiment, the NFC control unit is coupled with the BMC and configured to access the system datum in the storage unit via the BMC. In another embodiment, the NFC control unit is coupled with the storage unit via a signal transmission path that bypasses the BMC. The NFC control unit is then configured to access the system datum in the storage unit via the signal transmission path.

In one embodiment, the NFC module receives data from an external device by NFC and transmits the data to the BMC. Said data is a first file in one embodiment. In another, said data is a first command based on which the BMC transmits a second file to the external device by NFC or manages the server system. Said data in yet another embodiment is a firmware file whereby the BMC performs a firmware update. Said data is a boot/shutdown command in yet another embodiment. The BMC executes a boot/shutdown procedure of the server system based on the boot/shutdown command.

In one embodiment, the NFC module is subject to the BMC and further configured to selectively transmit a BMC log to an external device by NFC. In one embodiment, the BMC log is included in the system datum and thus also stored in the storage unit.

In one embodiment, the NFC module, by NFC, is further configured to read data stored in an external device or communicate with another NFC module of another server system. In one embodiment, the BMC is coupled with the NFC module via an Intelligent Platform Management Bus (IPMB). The server system can communicate with another BMC of the other server system via the BMC, the IPMB, the NFC module, and the other NFC module. The NFC module may be detachably connected with a motherboard of the server system. The NFC module may be electrically supplied by a standby power of the server system when an externally attached power of the server system is functioning and the server system is not turned on.

In one embodiment, the server system further comprises a BIOS which transmits a system configuration file to the BMC in a power-on self-test. The BMC thereby generates or modifies the system datum.

In one embodiment, the server system further comprises a CPLD configured to transmit a CPLD firmware file to the BMC, which thereby generates or modifies the system datum.

Another disclosed server system comprises a central processing module, a BIOS, a storage unit, and an NFC module coupled with the storage unit. The BIOS is configured to manage the server system and to generate or modify a system datum. The storage unit is configured to store the system datum. The NFC module is configured to selectively access the system datum in the storage unit and to selectively transmit the system datum by NFC. In one embodiment, the NFC module is further configured to receive a system configuration file by NFC and store the system configuration file in the storage unit. The server system may be configured therewith during a subsequent boot.

Yet another disclosed server system comprises a central processing module, a CPLD, a storage unit, and an NFC module coupled with the storage unit. The CPLD is configured to manage the server system and to generate or modify a system datum. The storage unit is configured to store the system datum. The NFC module is configured to selectively access the system datum in the storage unit and to selectively transmit the system datum by NFC. In one embodiment, the NFC module is further configured to receive a CPLD firmware file by NFC and store the CPLD firmware file in the storage unit. The CPLD may thereby perform a firmware update.

In short, each the several server systems disclosed by the present invention comprises an NFC module and a storage unit. In conjunction with the management module, the BMC, the BIOS, or the CPLD that the server system further comprises, the NFC module is configured to selectively access or transmit by NFC the system datum in the storage unit, and may receive data or communicate with a peer by NFC.

### BRIEF DESCRIPTION OF THE DRAWING

The present invention will become more fully understood from the detailed description given hereinbelow and the accompanying drawings which are given by way of illustration only and thus are not limitative of the present invention and wherein:

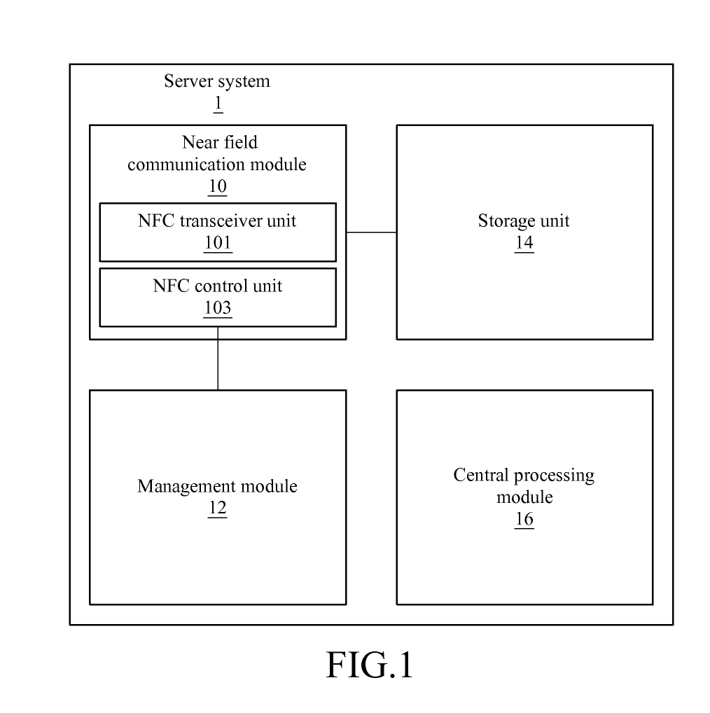

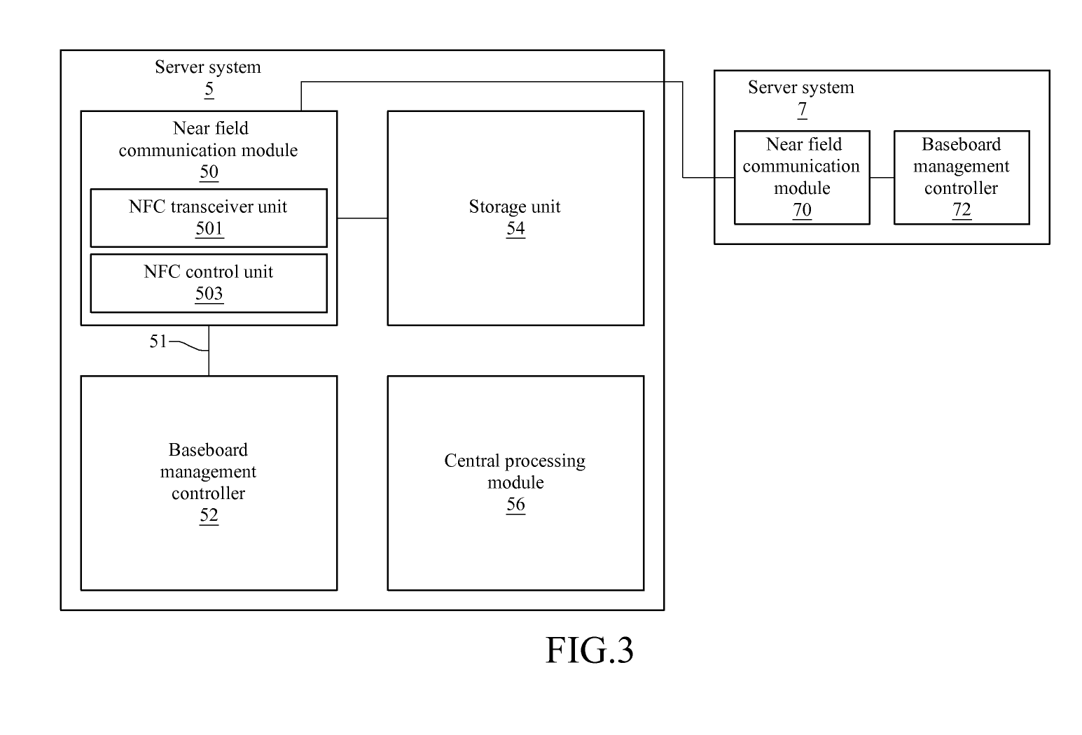

Each of FIGS. 1 through 6 is a block diagram of a server system, in accordance with various embodiments of the present invention. FIG. 3 shows additionally another server system.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings. For example, the volatile random-access memory (RAM, e.g. dual in-line memory modules or DIMM), heat-dissipation modules, power supply, hard disk drives, RAID (redundant array of independent disks) card, sensors for the a aforementioned hardware, etc that the server 1 may include are not depicted in FIGS. 1 through 6.

Please refer to FIG. 1. As shown in the block diagram, a server system 1 comprises a near field communication (NFC) module 10, a management module 12, a storage unit 14, and a central processing module 16. The NFC module 10 is coupled with the storage unit 14 and comprises an NFC transceiver unit 101 and an NFC control unit 103. The NFC control unit 103 is coupled with the management module 12. The central processing module 16 may comprise at least one central processing unit (CPU) of the server system 1. The management module 12 is a generalized component configured to manage an aspect of the server system 1 and to generate or modify a system datum corresponding to that aspect. The system datum is stored in the storage unit 14, which may be an independent component of the server system 1 or conceptually subordinate to the NFC module 10 or the management module 12. The storage unit 14 may be coupled with the management module 12 to receive from the management module 12 the system datum or a modification thereof The storage unit 14 may be flash memory or other EEPROM (electrically erasable programmable read-only memory). Of course, the storage unit 14 may as well be volatile given that electric power is assured.

As a transceiver, the NFC transceiver unit 101 may comprise an antenna for NFC. The NFC module 10 is configured to selectively access the said system datum. For example, an NFC-capable external device situated sufficiently close to the antenna (by less than, say, 10 centimeters) may cause the NFC module 10 to access the system datum from the NFC control unit 103 via the management module 12. In practice, it might be that the NFC control unit 103 asks the management module 12 for access rights to the storage unit 14, and the NFC module 10 accesses the storage unit 14 only after the rights are granted. When the storage unit 14 is coupled with the management module 12, it might also be that the management module 12 is responsible for forwarding the system datum from the storage unit 14 to the NFC control unit 103. The NFC module 10 is also configured to selectively transmit the system datum by NFC. As implied above, the NFC module 10 may transmit the system datum to the external device from the NFC transceiver unit 101. In NFC terms, the external device is usually a contactless card or tag or operates in the card emulation mode, performing basic interaction with the NFC module 10.

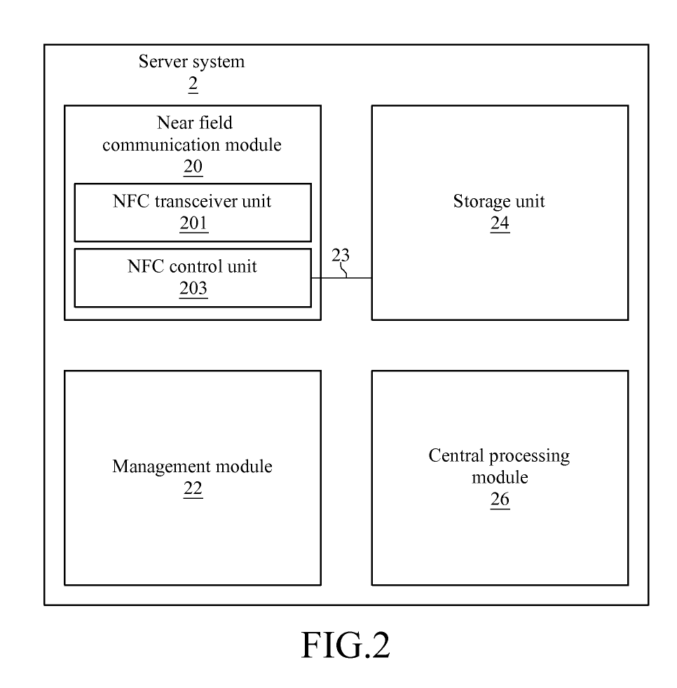

Please refer to FIG. 2. As shown in the block diagram, a server system 2 comprises an NFC module 20, a management module 22, a storage unit 24, and a central processing module 26. The NFC module 20 comprises an NFC transceiver unit 201 and an NFC control unit 203 and is coupled with the storage unit 24 at the NFC control unit 203 via a signal transmission path 23. The NFC transceiver units 201 and 101 are similar. The central processing modules 26 and 16 are similar. The management modules 22 and 12 are similar, but the former is not necessarily coupled with the NFC module 20. The storage units 24 and 14 are similar in that the former may be independent or conceptually subordinate to the NFC module 20 or the management module 22. The storage unit 24 may be coupled with the management module 22 to receive from the management module 22 the system datum or a modification thereof.

In the embodiment of FIG. 2, the NFC module 20, in particular the NFC control unit 203, is configured to access the storage unit 24 via the signal transmission path 23. Please note that the signal transmission path 23 does not pass through the management module 22, ensuring that the NFC module 20 could still retrieve the system datum if the management module 22 failed. The coupling between the NFC module 10 and the storage unit 14 in FIG. 1 may be similar to the signal transmission path 23. In one embodiment, full-duplex communication is implemented on the coupling between the NFC module 10 and the storage unit 14 or the coupling between the NFC module 20 and the storage unit 24 according to the Single Wire Protocol (SWP).

In one embodiment, the NFC module 10 or 20 is further configured to communicate with the NFC module of another server system. When this external NFC module is situated sufficiently close to the NFC module 10 or 20, both parties can interact in the peer-to-peer mode. In another embodiment, the NFC module 10 or 20 is further configured to read data stored in an NFC-capable external device situated sufficiently close. The external device may be a card or a tag, to which the NFC module 10 or 20 operates in the reader/writer mode.

In FIG. 1 or 2, the former for example, the NFC module 10 may be detached from and attached to the case or a motherboard of the server system 1, and the antenna of the NFC transceiver unit 101 may be disposed on the front input/output board of the case. Depending on the subordination of the storage unit 14, the NFC module 10 may be independently detachable, or may have to be installed or removed along with the storage unit 14 when the storage unit 14 and the NFC module 10 are integrated.

Please refer to FIG. 3. As shown in the block diagram, a server system 5 comprises an NFC module 50, a baseboard management controller (BMC) 52, a storage unit 54, and a central processing module 56. The NFC modules 50 and 10 are similar, the former comprising an NFC transceiver unit 501 and an NFC control unit 503. The NFC transceiver units 501 and 101 are similar. The NFC module 50 is coupled with the storage unit 54 and, via an Intelligent Platform Management Bus (IPMB) 51, with the BMC 52. In one embodiment, the IPMB 51 is extended to the NFC control unit 503 so that the NFC control unit 503 is coupled with the BMC 52. The storage units 54 and 14 are similar. The central processing modules 56 and 16 are similar.

The BMC 52, configured to manage the server system 5 and generate or modify the system datum, is similar to the management module 12. The BMC 52 is usually part of the Intelligent Platform Management Interface (IPMI) of the server system 5. As the processing core of the IPMI, the BMC 52 monitors sensors at multiple locations within the server 5 to get a handle of and automatically report the temperature, power stability, or other operational status (i.e. the system datum) of the server system 5.

FIG. 3 also schematically shows another server system 7, which comprises an NFC module 70 and a BMC 72. The NFC module 70 may be, but not necessarily, coupled with the BMC 72 via another IPMB. The coupling between the NFC modules 50 and 70 signifies the NFC channel, which appears when, say, the two are situated close enough. In one application scenario, a component or remote management console of the server system 5, such as the central processing module 56 or the BMC 52 itself, is able to communicate with the BMC 72 via the BMC 52, the IPMB 51, and the NFC modules 50 and 70. The application scenario might be that the server system 7, at least partially broken or defective, actively or passively triggers the remote management console to maintain the server system 7 through the IPMI. Of course the server system 5 might be maintained by the server system 7 as well. The said application scenario generally implies that the NFC modules 50 and 70 operate in the peer-to-peer mode.

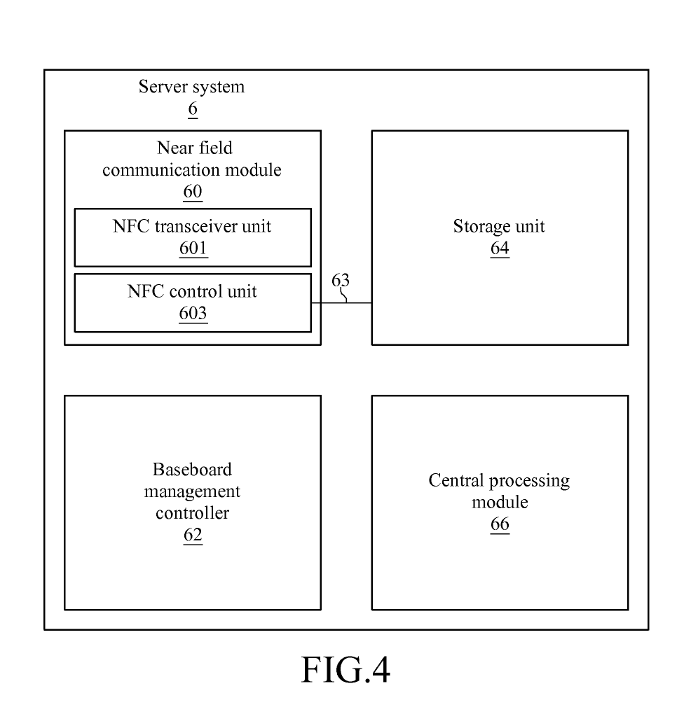

Please refer to FIG. 4. As shown in the block diagram, a server system 6 comprises an NFC module 60, a BMC 62, a storage unit 64, and a central processing module 66. The NFC modules 60 and 20 are similar, the former comprising an NFC transceiver unit 601 and an NFC control unit 603 and coupled with the storage unit 64 at the NFC control unit 603 via a signal transmission path 63. Please note that the signal transmission path 63 does not pass through the BMC 62, ensuring that the NFC module 60 could still retrieve the system datum if the BMC 62 failed. The NFC transceiver units 601, 201, and 101 are similar. The central processing modules 66, 26, and 16 are similar. The BMCs 62 and 52 are similar, but the former is not necessarily coupled with the NFC module 60. The storage units 64 and 24 are similar.

The following description applies to FIGS. 3 and 4. Take the server system 6 for example. In some embodiments, the NFC module 60 receives data from an NFC-capable external device and transmits that data to the BMC 62. The data is an arbitrary file in one embodiment. In another, the data is a command, based on which the BMC 62 performs some management operation of the server system 6, or transmits a file to the external device by NFC. The management operation may be the BMC 62 executing the boot or shutdown procedure of the server system 6, whereas the file transmitted may be, but not necessarily, stored in the storage unit 64. In yet another embodiment, said data is a firmware file whereby the BMC 62 performs a firmware update within the server system 6, e.g. one for the BMC 62 itself.

The NFC module 60 can also transmit data other than the system datum to the aforementioned external device. For instance, in the server system 6 there may be a BMC log associated with the BMC 62. The log may be maintained by the BMC 62, may be part of the system datum, and may be, but not necessarily, stored in the storage unit 64. When the external device is situated sufficiently close to the NFC 60, the NFC 60 transmits the BMC log.

The server system 6 may have a backup or standby power aside from the main electrical supply. Due to the existence of the IPMI, the standby power can keep the BMC 62 operational while the server system 6 is shut down. In one embodiment, the NFC module 60 is also electrically supplied by the standby power at least when an externally attached power of the server system 6 is functioning and the server system 6 is not turned on. In other words, the NFC module 60 is able to selectively transmit the system datum at any time.

In one embodiment, the server system 6 further comprises a basic input/output system (BIOS) similar to another BIOS 32 described hereinafter. This BIOS transmits a system configuration file to the BMC 62 during the stage of power-on self-test (POST), the BMC 62 thereby generating or modifying the said system datum. As noted below, the system configuration file may comprise configuration for the BIOS or the hardware of the server system 6. In another embodiment, the server system 6 further comprises a complex programmable logic device (CPLD) similar to another CPLD 42 described hereinafter. This CPLD is configured to transmit a firmware file relevant to itself to the BMC 62, which thereby again generates or modifies the system datum.

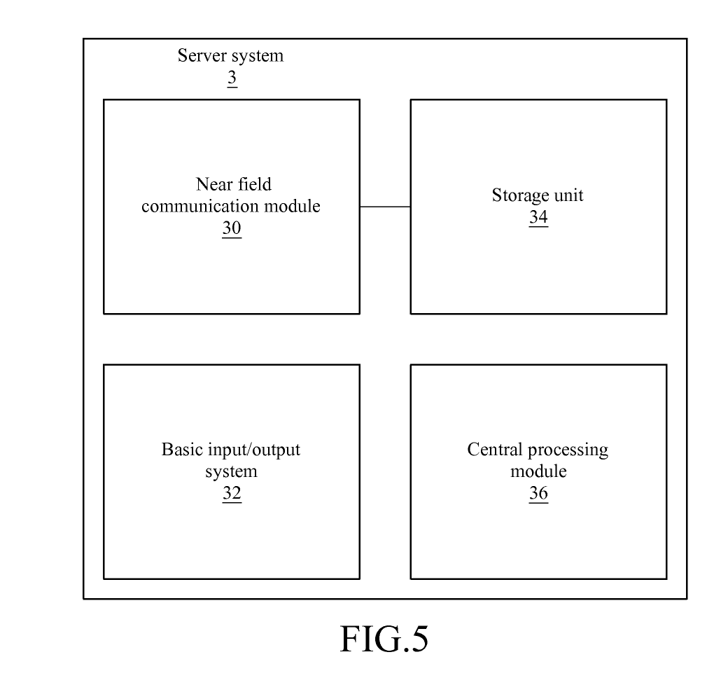

Please refer to FIG. 5. As shown in the block diagram, a server system 3 comprises an NFC module 30, a BIOS 32, a storage unit 34, and a central processing module 36. The NFC module 30, coupled with the storage unit 34, may be similar to the NFC module 10 or 20. The BIOS 32 may be coupled with the NFC module 30 or not in various embodiments. The storage units 34, 24, and 14 are similar. The central processing modules 36, 26, and 16 are similar.

The BIOS 32, similar to the management module 12 or 22, is configured to manage the server system 3 and generate or modify the system datum. Specifically, the operation of the BIOS 32 involves the central processing module 36 and a dedicated read-only memory which stores the machine code that a processor of the central processing module 36 first reads through its program counter as the server system 3 is booting. The processor, executing the machine code, functions as the BIOS 32. The BIOS 32 is generally regarded as a complete and independent function block.

The POST of the server system 3 may include the BIOS 32 disabling cores found to be broken during the built-in self-test of the central processing module 36, detecting and initializing the volatile RAM and disabling defective modules, scanning for peripheral hardware connected to the motherboard, distributing resource accordingly, and collecting relevant information based on the said steps, such as the number, health, make, model, and manufacture date of each component. The system datum may comprise such information.

In one embodiment, the NFC module 30 is further configured to receive a system configuration file by NFC and store it in the storage unit 34. The system configuration file may comprise settings for said hardware or the BIOS 32. The server system 3 can thereby adjust its own configuration during a boot. Conceptually, one of said system datum and system configuration file is actively acquired by the server system 3 while the other is passively received, but in practice they may be or may not be the same piece of data in the storage unit 34 and may be cross-checked. For instance, when the BIOS 32 is able to identify the source and purpose of the piece of data, the hardware configuration of the server system 3 can be verified or modified accordingly.

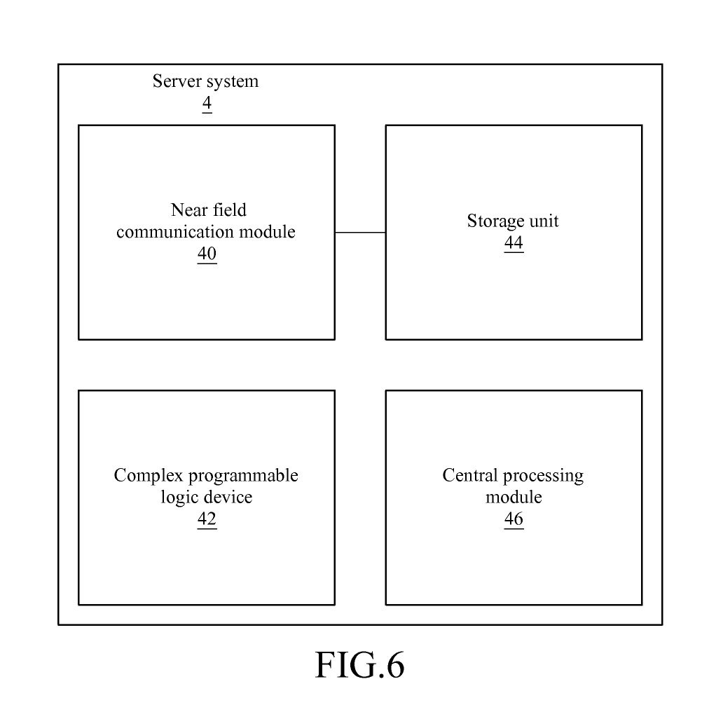

Please refer to FIG. 6. As shown in the block diagram, a server system 4 comprises an NFC module 40, a CPLD 42, a storage unit 44, and a central processing module 46. The NFC module 40, coupled with the storage unit 44, may be similar to the NFC module 10 or 20. The CPLD 42 may be coupled with the NFC module 40 or not in various embodiments.

The storage units 44, 24, and 14 are similar. The central processing modules 46, 26, and 16 are similar. The CPLD 42, similar to the management module 12 or 22, is configured to manage the server system 4 and generate or modify the system datum. Owing to its programmability, the CPLD 42 can in fact run any firmware. In one embodiment, a firmware file of the CPLD 42 is received by NFC and stored in the storage unit 44 by the NFC module 40. In one embodiment, the CPLD 42 in turn updates itself based on the firmware file to possess corresponding functionality.

To summarize, each of the server systems disclosed by the present invention comprises a storage unit, an NFC module, and a central processing module. A system datum of the server system is stored in the storage unit. The server system further comprises a management module, a BIOS, a CPLD or a BMC to generate or modify the system datum. In a variety of NFC modes, the NFC module is configured to selectively transmit a file, a BMC log, or the system datum to an external device, or receive or read a (boot/shutdown) command, a (firmware or system configuration) file or datum from the external device, or generally communicate with the external device. The present invention also discloses two embodiments in which the NFC module selectively accesses the storage unit: via the module generating or modifying the system datum, or via a dedicated signal transmission path, bypassing that module.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A server system comprising:
a central processing module;
a baseboard management controller (BMC) configured to monitor and manage the server system and to generate or modify a system datum relevant to the server system;
a storage unit configured to store the system datum; and
a near field communication (NFC) module coupled with the storage unit, configured to selectively access the system datum in the storage unit, and to selectively transmit the system datum by NFC.

2. The server system of claim 1, wherein the NFC module comprises:
an NFC transceiver unit; and
an NFC control unit coupled with the BMC and configured to access the system datum in the storage unit via the BMC.

3. The server system of claim 1, wherein the NFC module comprises:
an NFC transceiver unit; and
an NFC control unit coupled with the storage unit via a signal transmission path and configured to access the system datum in the storage unit via the signal transmission path, the signal transmission path bypassing the BMC.

4. The server system of claim 1, wherein in response to the NFC module receiving a first file from an external device by NFC, the NFC module transmits the first file to the BMC.

5. The server system of claim 1, wherein in response to the NFC module receiving a first command from an external device by NFC, the NFC module transmits the first command to the BMC, and the BMC, based on the first command, transmits a second file to the external device by NFC or manages the server system.

6. The server system of claim 1, wherein in response to the NFC module receiving a firmware file from an external device by NFC, the NFC module transmits the firmware file to the BMC, and the BMC performs a firmware update based on the firmware file.

7. The server system of claim 1, wherein the NFC module is subject to the BMC and further configured to selectively transmit a BMC log to an external device by NFC.

8. The server system of claim 1, wherein the system datum comprises a BMC log, and the NFC module is subject to the BMC and further configured to selectively transmit the BMC log in the storage unit to an external device by NFC.

9. The server system of claim 1, wherein in response to the NFC module receiving a boot/shutdown command from an external device by NFC, the NFC module transmits the boot/shutdown command to the BMC, and the BMC executes a boot/shutdown procedure of the server system based on the boot/shutdown command.

10. The server system of claim 1, wherein the NFC module is further configured to read, by NFC, data stored in an external device.

11. The server system of claim 1, wherein the NFC module is electrically supplied by a standby power of the server system when an externally attached power of the server system is functioning and the server system is not turned on.

12. The server system of claim 1, wherein the NFC module is detachably connected with a motherboard of the server system.

13. The server system of claim 1, wherein the NFC module is further configured to communicate with another NFC module of another server system by NFC.

14. The server system of claim 13, wherein the BMC is coupled with the NFC module via an Intelligent Platform Management Bus (IPMB), and the server system communicates with another BMC of the other server system via the BMC, the IPMB, the NFC module, and the other NFC module.

15. The server system of claim 1, further comprising a basic input/output system (BIOS), wherein the BIOS transmits a system configuration file to the BMC in a power-on self-test, and the BMC generates or modifies the system datum based on the system configuration file.

16. The server system of claim 1, further comprising a complex programmable logic device (CPLD) configured to transmit a CPLD firmware file to the BMC, wherein the BMC generates or modifies the system datum based on the CPLD firmware file.

17. A server system comprising:
a central processing module;
a management module configured to manage the server system and to generate or modify a system datum;
a storage unit configured to store the system datum; and
a near field communication (NFC) module coupled with the storage unit, configured to selectively access the system datum in the storage unit, and to selectively transmit the system datum by NFC.

18. The server system of claim 17, wherein the NFC module comprises:
an NFC transceiver unit; and
an NFC control unit coupled with the management module and configured to access the system datum in the storage unit via the management module.

19. The server system of claim 17, wherein the NFC module comprises:
an NFC transceiver unit; and
an NFC control unit coupled with the storage unit via a signal transmission path and configured to access the system datum in the storage unit via the signal transmission path, the signal transmission path bypassing the management module.

20. The server system of claim 17, wherein the NFC module is further configured to communicate with another NFC module of another server system by NFC.

21. The server system of claim 17, wherein the NFC module is further configured to read, by NFC, data stored in an external device.

22. The server system of claim 17, wherein the NFC module is detachably connected with a motherboard of the server system.

23. A server system comprising:
a central processing module;
a basic input/output system configured to manage the server system and to generate or modify a system datum;
a storage unit configured to store the system datum; and
a near field communication (NFC) module coupled with the storage unit, configured to selectively access the system datum in the storage unit, and to selectively transmit the system datum by NFC.

24. The server system of claim 23, wherein the NFC module is further configured to receive a system configuration file by NFC and store the system configuration file in the storage unit, and wherein the server system is configured with the system configuration file during a subsequent boot.

25. A server system comprising:
a central processing module;
a complex programmable logic device (CPLD) configured to manage the server system and to generate or modify a system datum;
a storage unit configured to store the system datum; and
a near field communication (NFC) module coupled with the storage unit, configured to selectively access the system datum in the storage unit, and to selectively transmit the system datum by NFC.

26. The server system of claim 25, wherein the NFC module is further configured to receive a CPLD firmware file by NFC and store the CPLD firmware file in the storage unit, and wherein the CPLD performs a firmware update based on the CPLD firmware file.
